(19) United States
(12) Patent Application Publication
(10) Pub. No.: US 2026/0263993 A1
(43) Pub. Date: Sep. 10, 2026

(54) COMPOSITIONS AND METHODS FOR CARBON DIOXIDE CAPTURE AND FLUID SWEETENING

(71) Applicant: Solugen, Inc., Houston, TX (US)

(72) Inventors: Amit Desai, Sugar Land, TX (US); Jun Su An, Houston, TX (US); Jason Helander, Richmond, TX (US); Chris Arceo, Richmond, TX (US)

(73) Assignee: Solugen, Inc., Houston, TX (US)

(21) Appl. No.: 19/163,317

(22) PCT Filed: Mar. 20, 2024
(86) PCT No.: PCT/US2024/020812

§ 371 Date: Sep. 8, 2025

Related U.S. Application Data
(60) Provisional application No. 63/491,100, filed on Mar. 20, 2023.

(51) Int. Cl. B01D 53/14; B01D 53/52; B01D 53/62; B01D 53/78; C10L 3/10

(52) U.S. Cl. CPC B01D 53/1493; B01D 53/1468; B01D 53/1475; B01D 53/52; B01D 53/62; B01D 53/78; C10L 3/103; C10L 3/104; B01D 2252/20405; B01D 2252/2041; B01D 2252/20421; B01D 2252/20489; B01D 2252/20494; B01D 2258/0283; C10L 2290/541

(57) ABSTRACT

A method of reducing an acid gas from an acid gas-containing fluid, the method comprising contacting the acid gas-containing fluid with a composition comprising an amine-derived from a sugar oxidation product wherein the amine-derived from a sugar oxidation product is selected from the group consisting of 2-amino-2-methyl-1-propanol, glucamine, hexamethylenediamine, glucosamine, benzylamine, glycinate and a combination thereof. A method comprising introducing to a reactor having an amine derived from a sugar oxidation product disposed therein an acid-gas containing fluid under conditions sufficient to remove from about 10% to about 90% of the acid gas from acid-gas containing fluid.

### CROSS-REFERENCE TO RELATED APPLICATIONS

This application is a 35 U.S.C. § 371 national stage application of PCT/US2024/020812 filed Mar. 20, 2024 and entitled “Compositions and Methods for Carbon Dioxide Capture and Fluid Sweetening,” which claims priority to U.S. Provisional Application No. 63/491,100 filed Mar. 20, 2023 and entitled “Compositions and Methods for Carbon Dioxide Capture and Fluid Sweetening,” each of which is hereby incorporated herein by reference in its entirety for all purposes.

### TECHNICAL FIELD

The present disclosure relates generally to compositions and methods for the capture of gases. More particularly, the present disclosure relates to compositions and methods for the capture of acid gases.

### BRIEF DESCRIPTION OF DRAWINGS

For a detailed description of the aspects of the disclosed processes and systems, reference will now be made to the accompanying drawings in which:

FIG. 1a depicts the reaction between an amine and carbon dioxide.

FIG. 1b depicts the reaction between an amine and hydrogen sulfide.

FIG. 2 depicts the structures of (a) glucamine, (b) hexamethylenediamine, (c) glucodiamine and (d) glucosamine.

FIG. 3 depicts a process flow diagram for a method of removing acid gases.

### BACKGROUND

Carbon dioxide is considered to be responsible for the majority of global warming caused by greenhouse gases. Carbon dioxide is a major greenhouse gas and is released, for example, through gaseous effluents, such as industrial gaseous effluents, especially when fossil fuels are burned to provide electricity and heat. Although efforts are underway to move toward renewable energy sources that do not emit greenhouse gases, shifting our energy supply to completely renewable sources is not feasible in the near term requiring further technological advancements and significant global investments.

Capture of carbon dioxide at the point of generation and subsequent trapping of CO₂ into the ground or conversion into useful chemicals is an effective strategy to address the adverse effects of rising carbon dioxide levels. Carbon capture and storage (CCS) is a way of reducing carbon emissions. CCS can generally be described as a three-step process, involving (1) capturing the carbon dioxide (e.g., produced by power generation or industrial activity, such as steel or cement making); (2) transporting the captured carbon dioxide; and then (3) storing the carbon dioxide deep underground. As well as CCS, there is a related concept, CCUS, which stands for Carbon Capture Utilization and Storage. For CCUS instead of storing carbon, the captured could be re-used in industrial processes by conversion into, for example, plastics, concrete or biofuel.

Another area of interest is the effective removal of acid gas impurities such as CO₂ and hydrogen sulfide, H₂S, from natural gas. Natural gas containing H₂S is referred to as “sour gas” consequently, the process of H₂S removal is referred to as gas sweetening. Besides reducing the gas energy value, H₂S can cause operational problems such as corrosion in the pipeline and other equipment. Sulfur components can produce SO₂ during combustion which ultimately leads to acid rain and iron sulfides that lead to scaling as well as under deposit corrosion.

CO₂ and H₂S are both acid gases which refer to any gaseous compound which, when dissolved in water, will form an acidic solution. There is an ongoing need for technologies that can efficiently remove acid gases such as CO₂ and H₂S from various sources.

### SUMMARY

Disclosed herein is a method of reducing an acid gas from an acid gas-containing fluid, the method comprising contacting the acid gas-containing fluid with a composition comprising an amine-derived from a sugar oxidation product wherein the amine-derived from a sugar oxidation product is selected from the group consisting of 2-amino-2-methyl-1-propanol, glucamine, hexamethylenediamine, glucosamine, benzylamine, glycinate and a combination thereof.

Also disclosed herein is a method comprising introducing to a reactor having an amine derived from a sugar oxidation product disposed therein an acid-gas containing fluid under conditions sufficient to remove from about 10% to about 90% of the acid gas from acid-gas containing fluid.

### DETAILED DESCRIPTION

Disclosed herein are methods and compositions for the capture of acid gases such as CO₂, H₂S or both. In an aspect, the methods and compositions disclosed herein result in the removal of acid gases such as CO₂ and/or H₂S from a fluid. The methods and attendant compositions disclosed herein for the removal of CO₂ and/or H₂S from these acid gas-containing fluids are designated acid gas capture techniques or AGCT.

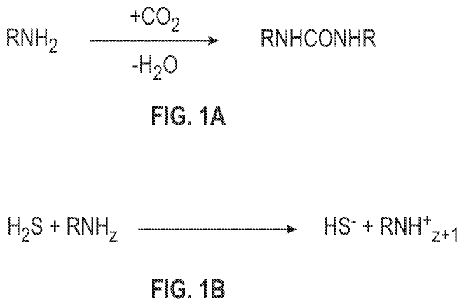

In an aspect, the AGCT comprises contacting an acid gas-containing fluid with an amine derived from a sugar oxidation product. FIG. 1a depicts the reaction between an amine and carbon dioxide to form carbamic acid. FIG. 1b depicts the reaction between an amine and hydrogen sulfide to form hydrosulfide.

In one or more aspects, the acid gas-containing fluid is a gas stream such as a flue gas, a natural gas from subterranean and other sources. In one or more aspects, the acid gas-containing fluid is derived from sources such as fossil fuel-based power plants, steel-making plants, biomass-based power plants, natural gas processing plants, synthetic fuel plants, refineries, petrochemical plants, cement plants, fossil fuel-based hydrogen production plants or combinations thereof.

In one or more aspects, the acid gas-containing fluid is flue gas. Flue gas may originate from the combustion of carbon-containing fossil fuels such as natural gas, oils, and/or lignite, as well as sub-bituminous, bituminous, and/or anthracite coals. The CO₂ content of a flue gas may vary from about 6 weight percent (wt. %) to about 15 wt. %, depending on the fuel type, with the highest levels coming from hard coal combustion and the lowest from natural gas. Other fluids that can be treated using an AGCT of the present disclosure can include, without limitation, syngas, shifted syngas produced in fuel gasification processes and gas streams from petrochemical plants whose composition can naturally depend on the process from which they are derived. In one or more aspects, the acid-gas containing fluid has an acid gas present in an amount of from about 0.1 wt. % to about 50 wt. %, or alternatively from about 1 wt. % to about 20 wt. %.

An amine derived from a sugar oxidation product suitable for use in the present may be formed from a process wherein a sugar oxidation product is aminated. In one or more aspects, the sugar oxidation product comprises aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof or a combination thereof. In one or more aspects, the sugar oxidation product comprises less than about 5 wt. % maltose, maltotriose, fructose, higher molecular weight polysaccharides, oxidation products thereof or combinations thereof based on the total weight of the sugar oxidation product.

In one or more aspects, the amine-derived from a sugar oxidation product is a component of a mixture. It is contemplated that the amine may be a component of the reaction product mixture, for example the product mixture resulting from amination of the sugar oxidation product. In such aspects, the amine comprises from about 50 weight percent (wt. %) to about 90 wt. % of the reaction product mixture, alternatively from about 50 wt. % to about 85 wt. % or alternatively from about 50 wt. % to about 75 wt. % based on the total weight of the reaction product mixture. In such aspects, the remainder of the reaction product mixture comprises solvent, sugar, one or more sugar oxidation products or a combination thereof.

In some aspects, the reaction product mixture is partially purified using any suitable methodology. For example, the reaction product mixture may be purified using chromatography, distillation, crystallization and the like. In such aspects, the amine is present in the partially purified reaction product mixture in an amount of from about 70 wt. % to about 99 wt. %, alternatively from about 80 wt. % to about 99 wt. % or alternatively from about 90 wt. % to about 99 wt. % based on the total weight of the partially purified reaction product mixture.

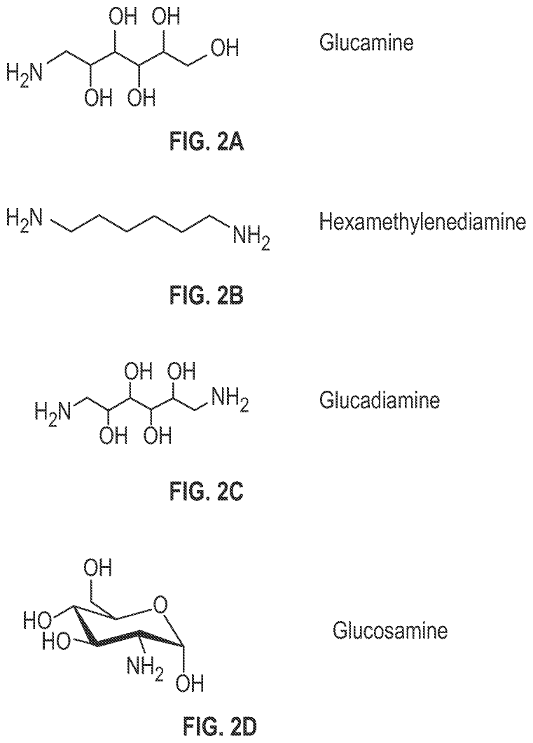

Nonlimiting examples of amines-derived from a sugar oxidation product that are suitable for use in the present disclosure include 2-amino-2-methyl-1-propanol, glucamine, hexamethylenediamine, glucosamine, benzylamine, glycinate and a combination thereof. The structures of glucamine, hexamethylenediamine, glucodiamine, and glucosamine are depicted in FIG. 2. In one or more aspects, the amine-derived from a sugar oxidation product comprises benzylamine.

In one or more aspects, the amine-derived from a sugar oxidation product is contacted with an acid-gas containing fluid. In such aspects, the amine-derived from a sugar oxidation product is present in an amount sufficient to provide an amine to acid gas molar ratio of about 1:0.1, alternatively from about 1:0.5, or alternatively from about 1:1.

An amine-derived from a sugar oxidation product may be utilized in an AGCT in an amount effective to reduce the concentration of acid gas (e.g., CO₂ m H₂S) from a fluid (e.g., flue gas) to some user and/or process desired concentration. For example, an amine-derived from a sugar oxidation product may be contacted with a fluid containing an acid gas under conditions suitable for the capture of at least a portion of the acid gas. In such aspects, the amine-derived from a sugar oxidation product may reduce the amount of acid gas in the acid gas-containing fluid by equal to or greater than about 10%, alternatively equal to or greater than about 20%, alternatively equal to or greater than about 30%, alternatively equal to or greater than about 40%, alternatively equal to or greater than about 50%, alternatively equal to or greater than about 60%, alternatively equal to or greater than about 70%, alternatively equal to or greater than about 80%, alternatively equal to or greater than about 90% or alternatively from about 10% to about 90% of the acid gas when compared to the amount of acid gas present in the original acid gas-containing fluid.

In one or more aspects, the AGCT comprises a second amine such as butylamine, diethyl amine, monoethanolamine, dipropylamine, triethylamine and combinations thereof. In aspects wherein a second amine is present, the total amount of amine in the AGCT may be sufficient to provide a total amine to acid gas molar ratio of about 1:0.1, alternatively from about 1:0.5, or alternatively from about 1:1.

In one or more aspects, a solvent is included with the amine-derived from a sugar oxidation product whether the amine-derived from a sugar oxidation product is partially purified, purified or a component of a reaction product mixture. Nonlimiting examples of solvents suitable for use with the amine-derived from a sugar oxidation product include methanol, ethanol, water, acetonitrile, and combinations thereof. The solvent may be present in any amount suitable to meet one or more user and/or application goals.

It is contemplated that contacting of the amine-derived from a sugar oxidation product with the acid-gas containing fluid results in the formation of one or more stable compounds that can be separated from the acid-gas containing fluid.

Any suitable methodology for contacting of the amine-derived from a sugar oxidation product with the acid-gas containing fluid may be used. For example, the amine-derived from a sugar oxidation product may be a liquid disposed within a container and the acid-gas containing fluid may be bubbled through the liquid under conditions suitable for the formation of one or more stable compounds.

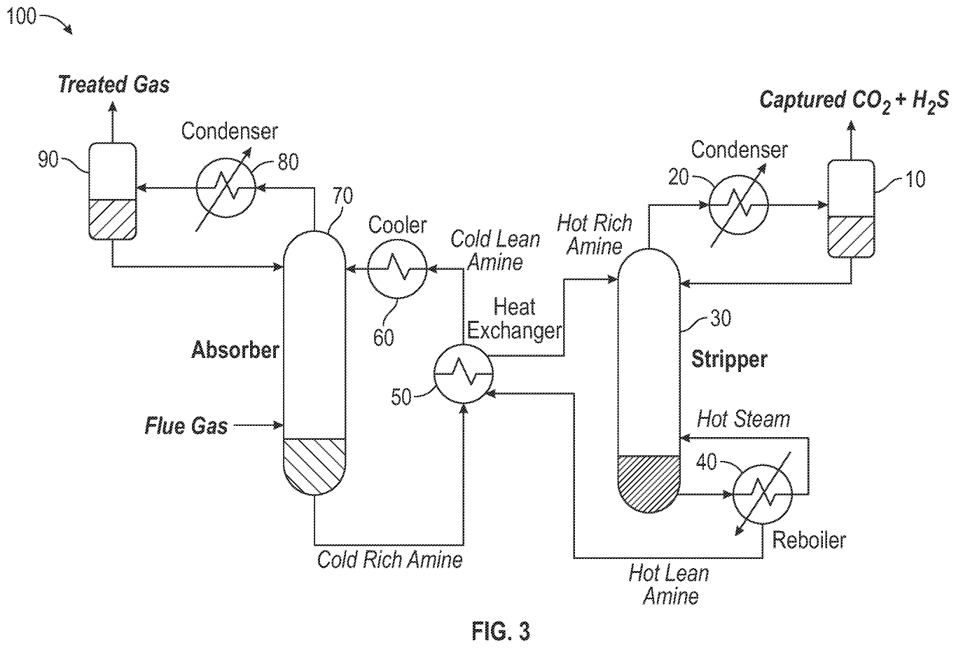

With reference to FIG. 3, a process flow diagram for acid gas removal (e.g., CO₂ H₂S) capture by absorption using an amine-derived from a sugar oxidation product solution is depicted. The reactor 100 comprises an absorber 70 and a stripping unit 30 having disposed therein an amine-derived from a sugar oxidation product solution at a concentration sufficient to capture or removing the acid gas from a stream being treated. The process flow diagram depicts a reactor 100 that can be placed in proximity to a stream comprising an acid gas (e.g., flue gas from an exhaust or stack gas) where the acid gas containing fluid can be conveyed from the combustion process to the reactor 100. Hereinafter the disclosure will refer to a stream to be treated as comprising CO₂ although it is to be understood the stream may comprise H₂S instead of or in conjunction with CO₂. The stream to be treated (e.g., flue gas) may contain nitrogen, carbon dioxide and water and enter the reactor 100 through vessel 10. In some aspects, the process for removal of CO₂ comprises absorption facilitated by cooling the stream to be treated, for example, through a Direct Contact Cooler (DCC) using a condenser 20 and water. The cooled stream containing CO₂ may then be conveyed to a striper vessel 30 having disposed therein a solution comprising an amine-derived from a sugar oxidation product. In some aspects the solution comprising an amine-derived from a sugar oxidation product in the stripper vessel 30 may have the same an amine-derived from a sugar oxidation product present in the absorber vessel 70. Alternatively, the amine-derived from a sugar oxidation product solution in the stripper vessel 30 differs from the amine-derived from a sugar oxidation product solution in the absorber vessel 70. In an aspect, an amine-derived from a sugar oxidation product solution disposed within a stripper vessel 30 is heated. The heated an amine-derived from a sugar oxidation product solution is termed a hot rich amine solution. The hot rich amine-derived from a sugar oxidation product solution in stripper vessel 30 may become depleted in amine (i.e. a reduced amine concentrations) as the amine-derived from a sugar oxidation product reacts with CO₂ resulting in the formation of carbamates and a lean amine solution. The gas exiting stripper vessel 30 may be cooled using a heat exchanger 40 and cooler 50 before being conveyed to an absorber 70 containing a cold rich amine (i.e., an amine-derived from a sugar oxidation product) solution where the CO₂ and water are separated before the treated gas is conveyed to a storage vessel 90. As the absorption and desorption process described herein are exothermic and endothermic processes, respectively, condensers, heat exchangers, coolers, and reboilers are used to manage the temperature during the removal and capturing processes described herein.

The removal of acid gases (carbon dioxide and/or hydrogen sulfide) from gas streams is of great industrial importance and commercial value. Carbon dioxide is a ubiquitous and inescapable by-product of the combustion of hydrocarbons, and there is growing concern over its accumulation in the atmosphere and its potential role in global climate change. Amines-derived from a sugar oxidation product compounds disclosed herein advantageously function as carbon dioxide and hydrogen sulfide capture agents that are derived from renewable resources.

### ADDITIONAL DISCLOSURE

The following are additional nonlimiting aspects of the present disclosure:

A first aspect which is a method of reducing an acid gas from an acid gas-containing fluid, the method comprising contacting the acid gas-containing fluid with a composition comprising an amine-derived from a sugar oxidation product wherein the amine-derived from a sugar oxidation product is selected from the group consisting of 2-amino-2-methyl-1-propanol, glucamine, hexamethylenediamine, glucosamine, benzylamine, glycinate and a combination thereof.

A second aspect which is the method of the first aspect wherein the amine derived from a sugar oxidation product is benzylamine.

A third aspect which is the method of any of the first through second aspects wherein the amine derived from a sugar oxidation product is hexamethylenediamine.

A fourth aspect which is the method of any of the first through third aspects wherein the sugar oxidation product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof, or a combination thereof.

A fifth aspect which is the method of any of the first through fourth aspects wherein the amine derived from a sugar oxidation product is a component of a reaction product mixture.

A sixth aspect which is the method of the fifth aspect wherein the amine derived from a sugar oxidation product comprises from about 50 wt. % to about 90 wt. % amine based on the total weight of the reaction product mixture.

A seventh aspect which is the method of any of the fifth through sixth aspects wherein the amine derived from a sugar oxidation product is partially purified.

An eighth aspect which is the method of the seventh aspect wherein the amine derived from a sugar oxidation product comprises from about 40 wt. % to about 99 wt. % amine based on the total weight of the reaction product mixture.

A ninth aspect which is the method of any of the first through eighth aspects wherein the amine-derived from a sugar oxidation product is present in an amount to provide an amine to acid gas molar ratio of about 1:0.1.

A tenth aspect which is the method of any of the first through ninth aspects wherein the composition further comprises a solvent.

An eleventh aspect which is the method of the tenth aspect wherein the solvent comprises methanol, ethanol, water, acetonitrile, and combinations thereof.

A twelfth aspect which is a method comprising introducing to a reactor having an amine derived from a sugar oxidation product disposed therein an acid-gas containing fluid under conditions sufficient to remove from about 10% to about 90% of the acid gas from acid-gas containing fluid.

A thirteenth aspect which is the method of the twelfth aspect wherein the amine-derived from a sugar oxidation product is selected from the group consisting of 2-amino-2-methyl-1-propanol, glucamine, hexamethylenediamine, glucosamine, benzylamine, glycinate and a combination thereof.

A fourteenth aspect which is the method of any of the twelfth through thirteenth aspects wherein the amine derived from a sugar oxidation product is benzylamine.

A fifteenth aspect which is the method of any of the twelfth through fourteenth aspects wherein the amine derived from a sugar oxidation product is hexamethylenediamine.

A sixteenth aspect which is the method of any of the twelfth through fifteenth aspects wherein the sugar oxidation product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof, or a combination thereof.

A seventeenth aspect which is the method of any of the twelfth through sixteenth aspects wherein the amine derived from a sugar oxidation product is a component of a reaction product mixture.

An eighteenth aspect which is the method of the seventeenth aspect wherein the amine derived from a sugar oxidation product comprises from about 50 wt. % to about 90 wt. % amine based on the total weight of the reaction product mixture.

A nineteenth aspect which is the method of any of the seventeenth through eighteenth aspects wherein the amine derived from a sugar oxidation product is partially purified.

A twentieth aspect which is the method of the nineteenth aspect wherein the amine derived from a sugar oxidation product comprises from about 40 wt. % to about 99 wt. % amine based on the total weight of the reaction product mixture.

A twenty-first aspect which is the method of any of the twelfth through twentieth aspects wherein the amine-derived from a sugar oxidation product is present in an amount to provide an amine to acid gas molar ratio of about 1:0.1.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

The ability of an amine-derived from a sugar oxidation product to capture acid gases was investigated. For these experiments, deionized (DI) water was generated in-house. Analytical grades of D-glucamine, hexamethylene diamine (HMDA), glycine, and sodium glycinate were procured from commercial vendors. Technical grade monethanolamine and food grade glucosamine were procured from commercial vendors. 2-amino-2-methyl-1-propanol was procured from a distributor as ANGUS AMP-95. Potassium glycinate was made by mixing 50 wt. % potassium hydroxide solution and 20 wt % glycine solution in a ratio that corresponded to 1:1 molar ratio of potassium hydroxide to glycine.

Carbon dioxide absorption (i.e., capture) was measured using a set-up consisting of bubbling carbon dioxide using a COTOUXKER CO₂ Bike Tire Inflator and a 16 g CO₂ cartridge commercially available from Impeccable Culinary Object. Carbon dioxide was bubbled through the solution at room temperature and pressure and the weight change was monitored until the CO₂ cartridge was empty.

Table I lists the different samples tested with the wt. % of the indicated concentration compound in the solution based on the total weight of the solution, the molar fraction absorbed and the wt. % fraction absorbed.

TABLE I

| | Concentration | Mole Fraction | Weight Fraction |
|---|---|---|---|
| Sample | wt. % | Absorbed | Absorbed (%) |
| water | 100 | 0.00 | 0 |
| monoethanolamine | 30 | 0.33 | 24 |
| D-glucamine | 27 | 0.34 | 8 |
| HMDA | 60 | 0.81 | 31 |
| ANGUS AMP-95 | 100 | 0.05 | 2 |
| glucosamine | 18 | 0.00 | 0 |
| glycine | 20 | 0.07 | 4 |
| K-glycine | 23 | 0.39 | 15 |
| Na-glycine | 50 | 0.17 | 8 |
| benzylamine | 30 | 0.53 | 22 |

Data in Table I indicates that sugar-derived amines and potassium glycinate have carbon dioxide absorption capacity similar to the incumbent amine, monoethanolamine.

The subject matter having been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A composition, comprising:
a sugar oxidation product; and
at least one material selected from the group consisting of oxides, nitrates, nitrites, sulfates, minerals, proteins, amino acids, macronutrients, and micronutrients.

2. The composition of claim 1, wherein the sugar oxidation product comprises aldaric acid, uronic acid, glucaric acid, gluconic acid, glucuronic acid, carboxylic acids, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof or combinations thereof.

3. The composition of claim 1, wherein the sugar oxidation product comprises less than about 5 wt. % maltose, maltotriose, fructose, higher molecular weight polysaccharides, oxidation products thereof or combinations thereof based on the total weight of the sugar oxidation product.

4. The composition of claim 1, wherein the sugar oxidation product comprises gluconic acid, glucaric acid, salts thereof, derivatives thereof of or combinations thereof.

5. The composition of claim 1, wherein the sugar oxidation product is present in an amount of from about 0.001 wt. % to about 5 wt. % based on the total weight of the composition.

6. The composition of claim 1, further comprising fish meal, fish oil, rice bran, shrimp bran, wheat bran, soybean cake, cottonseed cake, dried potatoes, corn, corn oil, rapeseed oil, sunflower oil, vegetable oil, palm oil, ground nut oil, cottonseed oil, cocoa butter oil, soya oil, or combinations thereof.

7. The composition of claim 1, further comprising alfalfa meal, hay, Bermuda coastal grass hay, corn plant, soybean hay, barley, corn, oats, rice, sorghum, wheat, canola meal, cottonseed cakes and meals, peanut meal, safflower meal, soybean (organic and genetically modified) feed and meal, distillers products, brewers dried grains, corn gluten, sorghum germ cake and meal, peanut skins, wheat bran, dried citrus pulp, apple pomace, pectin pulp, beet, citrus, starch, cane molasses, meat meal, meat meal tankage, meat and bone meal, poultry meal, animal by-product meal, dried animal blood, blood meal, feather meal, egg-shell meal, hydrolyzed whole poultry, hydrolyzed hair, bone marrow; animal digest from dead, dying, diseased, or disabled animals including deer and elk; dried ruminant waste, dried swine waste, dried poultry litter, undried processed animal waste products, fish meal, fish residue meal, crab meal, shrimp meal, fish oil, fish liver and glandular meal, fish by-products, animal fat, vegetable fat or oil, and hydrolyzed fats, edible food waste from restaurants, bakeries, and cafeterias, tetracyclines, macrolides, fluoroquinolones, streptogramins, spent mycelium and fermentation products, roxarson, arsanilic acid, copper compounds, metal amino acid complexes, urea, ammonium chloride, ammonium sulfate, bone charcoal, calcium carbonate, chalk rock, iron salts, magnesium salts, oyster shell flour, Vitamin A, Vitamin D, Vitamin B12, Vitamin E, niacin, betaine, Aspergillis niger, Bacillus subtilis, Bifidobacterium animalis, Enterococcus faecium, yeast, aloe vera gel concentrate, ginger, capsicum, fennel, phytase, cellulase, lactase, lipase, pepsin, catalase, acetic acid, sulfuric acid, aluminum salts, dextrans, glycerin, beeswax, sorbitol, riboflavin, butylated hydroxyanisole (BHA), sodium bisulfite, herbal products, botanical products, polyethylene roughage replacement or a combination thereof.

8. A method, comprising:
providing an animal a composition comprising a sugar oxidation product and at least one material selected from the group consisting of oxides, nitrates, nitrites, sulfates, minerals, proteins, amino acids, macronutrients, and micronutrients.

9. The method of claim 8, wherein the animal is selected from the group consisting of bovinae, cervidae, lagomorphs, oves, suidae birds, fish, crustaceans, and mollusks.

10. The method of claim 8, wherein the animal is a fish, crustacean, or mollusk.

11. The method of claim 8, further comprising assessing the physiology of the animal at some time period subsequent to providing the compositions.

12. The method of claim 11, wherein the animal displays (i) an increased total weight, (ii) a reduced phosphorous discharge, (iii) an increased survival rate or health benefit, (iv) increased feed conversion ratio, or (v) a combination thereof.

13. The method of claim 11, wherein the reduced phosphorous discharge ranges from about 10% to about 50% when compared to the phosphorous discharge of an organism provided an otherwise similar composition lacking a sugar oxidation product.

14. The method of claim 8, wherein the sugar oxidation product comprises gluconic acid, glucaric acid, salts thereof, derivatives thereof of or combinations thereof.

15. The method of claim 8, wherein the sugar oxidation is present in an amount of from about 0.001 wt. % to about 5 wt. % based on the total weight of the composition.

16. A composition, comprising:
a blend of a sugar oxidation product and a mixture comprising from about 18 weight percent (wt. %) to about 50 wt. % proteins, from about 10 wt. % to about 25 wt. % lipids, or combinations thereof.

17. The composition of claim 16, further comprising from about 15 wt. % to about 20 wt. % carbohydrates; less than about 8.5 wt. % phosphorus; less than about 1.5 wt. % water; and less than about 10 wt. % of vitamins and minerals based on the total weight of the feed.

18. The composition of claim 16, further comprising one or more fatty acids.

19. The composition of claim 18, wherein the fatty acids comprise omega-3 fatty acids, omega-6 fatty acids or combinations thereof.

20. The composition of claim 18, further comprising calcium, sodium, chloride, potassium, chlorine, sulfur, phosphorous, magnesium, iron, copper, chromium, iodine, manganese, zinc, selenium or combinations thereof.

21. The composition of claim 16, wherein the sugar oxidation product comprises gluconic acid, glucaric acid, salts thereof, derivatives thereof of or combinations thereof.
